(19) United States
(12) Patent Application Publication
(10) Pub. No.: US 2014/0201134 A1
(43) Pub. Date: Jul. 17, 2014

(54) METHOD AND SYSTEM FOR ESTABLISHING USER NETWORK GROUPS

(71) Applicants: Himmat Sankhla, Pune (IN); Samridh Kapoor, Mumbai (IN)

(72) Inventors: Himmat Sankhla, Pune (IN); Samridh Kapoor, Mumbai (IN)

(73) Assignee: Monk Akarshala Design Private Limited, Bangalore (IN)

(21) Appl. No.: 14/157,155

(22) Filed: Jan. 16, 2014

(30) Foreign Application Priority Data
Jan. 16, 2013 (IN) 232/CHE/2013

(51) Int. Cl. G06F 17/30

(52) U.S. Cl. CPC G06F 17/30289
USPC 707/609; 707/736

(57) ABSTRACT

The method and system for establishing user network groups based on commonality is disclosed. When a registered user logs in to the web-based application system, based on common non-user profile attributes, shortlisted common interest user(s) notifications would be displayed. Registered User can see the notifications and can visit those user profiles. User may add those notified common interest user(s) into his group/network. Thus user network groups can be established based on common non-user profile attributes/parameters in any web-based application system.

### FIELD OF THE INVENTION

The invention is in the field of establishing user network groups. More particularly the invention relates to a system and method for creation of user network groups such that each member of the group has at least one non-user profile attribute in common.

### BACKGROUND OF THE INVENTION

Users are willing to share their web spaces with other users, more particularly with those users who share common interests. For instance, a person who purchases a certain product would be more than willing to share his experiences with others who are planning to buy the same product. Alternatively if a purchaser has a bad experience with a seller, he would be even more than willing to share his experience with others not for the information but for taking out his frustration on the seller. In any case, the bottom line remains the same, that is, users are willing to share their experiences and connect and communicate with other users.

Current prior art indicates that such a relationship is generally based on some user profile attributes which are common. Such user profile attributes would, conventionally include attributes like locality, educational institutions, common or mutual friends etc.

Even though, grouping based on such parameters is effective but not accurate. This mode of grouping is effective in forming a huge social circle but might not play much of role on other occasions for instance, in case of e-learning or e-commerce application whereby it is not essential for individuals to form a group. Even if groups are formed in such environment they are generally limited to the groups which are formed based on locality or college or any such geographical limitations.

Grouping as per mode(s) described in prior art is not very effective or satisfactory over an e-commerce platform or e-learning platform. The main reason being that user on most of the commercial platforms possess more of individualistic outlook rather than a community interest and hence none of the E-commerce sites or E-learning sites provide for such functionality.

In view of above and consequently, there is need for a system and a method for forming user network groups whereby, the users is notified about a possibility of probable grouping or networking or connection based upon common interest(s) they share amongst themselves.

### SUMMARY OF THE INVENTION

Methods and systems for establishing user network group(s) based on common non-user profile attributes on a given web-based application are described herein. Particular aspects of the techniques and tools are described as follows.

Accordingly, when a registered user logs in to the web-based application, the system displays a notification containing user profiles, whereby the user profiles are shortlisted based on common non-user profile attributes. The registered user can see the notifications and can visit those notified user profiles. User may add those notified users into his group/network. Thus, user network groups can be established based on common non-user profile attributes in a given web-based application.

In another aspect, the invention provides a system for establishing user network group. The system of invention contains a user database, a commonality module, a commonality database, a notification module and a group database.

In yet another aspect, the invention provides a computer readable media which embodies instructions for establishing user network group based on commonality. The computer readable media of invention embodies instructions for signing up or logging in by the user in a web-based application, followed by generation and storing of commonality matrix based on non-user profile attributes and then based on the scrutiny of commonality matrix with regards to satisfaction of the pre-defined commonality condition and concludes with addition of the notified user profiles to the user group database of the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be made apparent from the following detailed description of embodiments that proceeds with reference to the accompanying drawings.

### BRIEF DESCRIPTION OF DRAWINGS

FIG. 1 illustrates a system for the establishing user network group based on commonality, in accordance with one embodiment.

FIG. 2 illustrates various components of the system for establishing user network group based on commonality.

FIG. 3 illustrates a process flowchart for the method of invention in accordance to one embodiment.

FIG. 4 illustrates components of an exemplary computer able to read instructions from a computer-readable medium and execute them in a processor (or controller) according to one embodiment.

FIG. 5 illustrates a commonality pop-up which would be displayed on the user device.

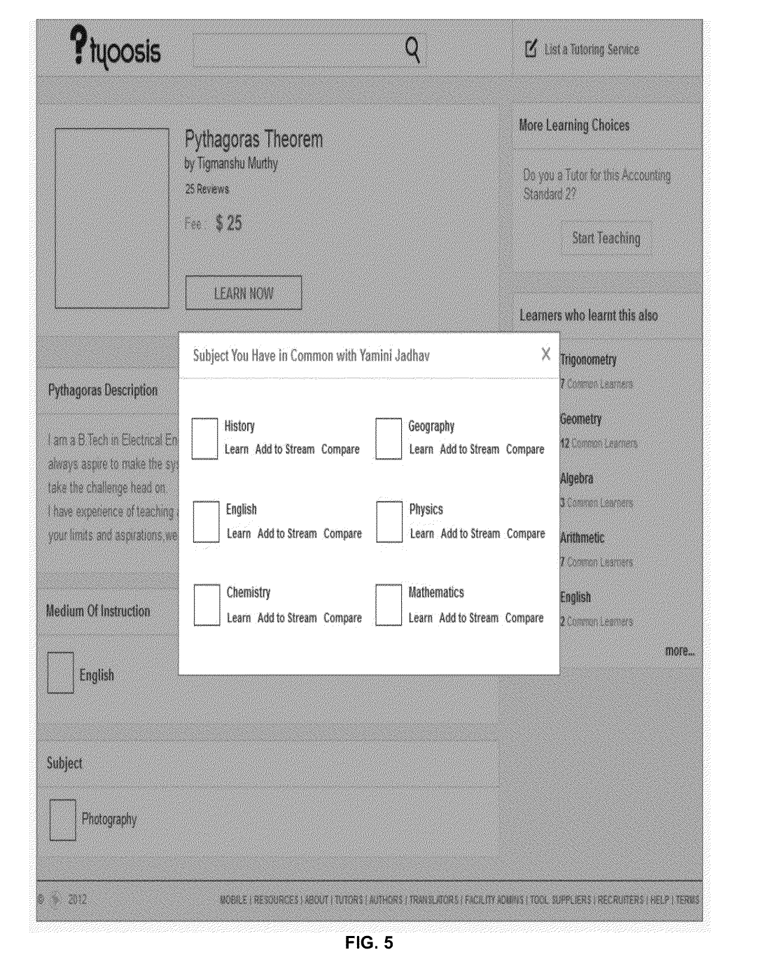

### DETAILED DESCRIPTION

The Figures (FIGS.) and the following description relate to embodiments by way of illustration only. It should be noted that from the following discussion, alternative embodiments of the systems, methods, figures, diagrams and interfaces disclosed herein will be readily recognized as viable alternatives that may be employed without departing from the principles of what is claimed.

It may be noted that the singular references like “a”, “an” and “the” also encompass the plural references, unless the context specifies otherwise. It may also be noted that any male references such as he, him, himself and any grammatical variations thereof also encompass the female gender.

The present invention describes a computer implemented method for notifying a user about a probable connection opportunity based on a common non-user profile attributes and for establishing user network groups based on such commonality. The invention further describes a system for notifying user about a probable connection opportunity based on the common interest or commonality. The invention further relates to a computer readable media embodying the instruction for method of invention.

For the purpose of this invention the term “common interests” encompasses those non-user profile attributes or data or fields or elements which are common for at least two users. The common interest could be collated together to form a commonality matrix.

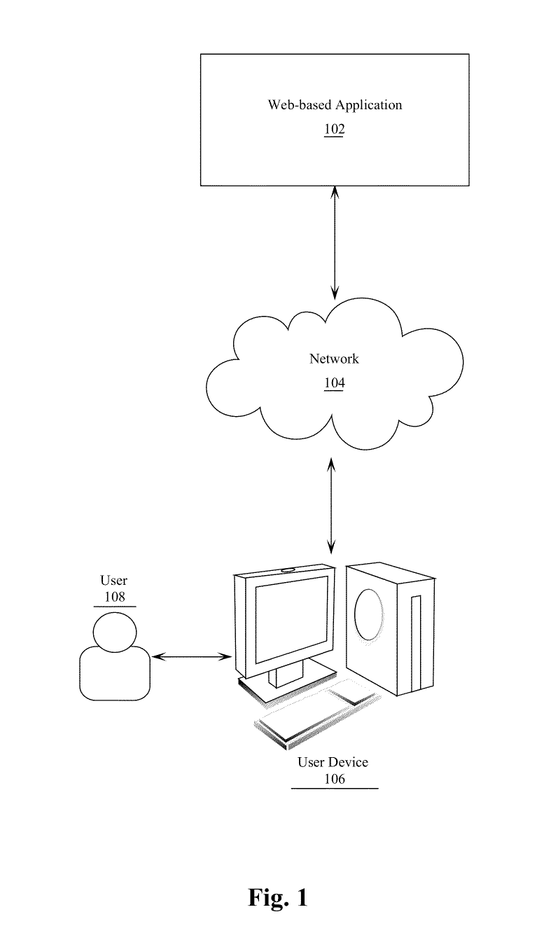

FIG. 1 illustrates a block diagram of the system of invention in accordance with an embodiment of the invention. The system of invention consists of a web-based application 102, a network component 104 through which a user 108 connects to the web-based application 102 using a user device 106.

The web-based application 102 is an application which provides services to the user 108. The services provided by the web-based application 102 may be educational services, social services or commercial services or any combination thereof. The services provided by said web-based application 102 could be free or paid services.

In an embodiment, the web-based application 102 is a modular learning system. The system in accordance with this embodiment, may manage, regulate and supervise the purchase, sale, preview, performance and review of a plurality of learning applications, each comprising, modularly, of a tutoring service, a learning application, learning facility access, and/or learning tools or infrastructure access, a learning visit, and/or a workshop. The web-based application 102 may further manage transactional and functional relationships between users of the modular learning system.

In subsequent embodiment, for modular learning system the user 108 may include, but not limited to, learners, tutors, authors, tool/material suppliers learning application template developers, translators, certifying user, learning facility administrators, learning event organizers, recruiters, and funders to modularly manage at least one of microtutoring services associated with specific learning applications, microlearning content applications, microlearning application templates, translation of microlearning content applications, certification of microlearning content applications, access to learning facilities, access to learning workshops, organization of learning visits associated with specific learning applications, supply of tools, aids and/or materials, recruitment services, as well as granular funding services.

In an alternative embodiment, the web-based application 102 is a commercial platform. Accordingly, the web-based application provides a platform for buying and selling goods. The web-based application may be an e-commerce application which might establish a buyer-seller relationship between registered users. In accordance with this embodiment, the user 108 can be a buyer or a purchaser and/or a seller or a vendor.

In another alternative embodiment, the web-based application may be a social networking application. Said social networking application may be professional networking application or personal networking application.

The User 108 is a person who logs on to a web-based application for availing the services offered by the web-based application. If the user 108 is visiting the web-based application for the first time, the user 108 can register (sign-up) himself on the said web-based application 102 through a user interface displayed on the user device 106 to avail/access the services offered by the said web-based application. Alternatively, a registered user 108 may log on the system through a user interface displayed on the user device 106. The User Device 106 may comprise any of a variety of computing devices, such as a desktop computer, a laptop, a mobile device, a tablet computer, a set-top box, a kiosk, interactive television, gaming console, and other computing platforms suitable for communicating with web based application 102.

In an embodiment, wherein the web-based application 102 is modular learning system, the user 108 may be a learning user or learner. In accordance with this embodiment the web-based application allows the learning user 108 to manage the purchase and performance of each module of a single microlearning service stack for a learning application or a group of learning applications offered by said modular learning system. Tutor access, such as access to a swimming instructor may be purchased in various increments, such as in hours. Learning content applications such as a breaststroke learning application with attached instructional media and other data may be purchased in timed access quantities or may be permanently purchased.

In another embodiment, wherein the web-based application 102 is modular learning system, the user 108 may be a tutoring user or tutor or teacher. In accordance with this embodiment, the tutoring user may associate themselves with particular pieces of content and may indicate qualifications to teach each learning application. The web-based application 102 manages the sale of microtutoring services and associated tutoring user with specific learning applications to learning user. Tutoring user assists the learning user with learning the subject matter of the learning application.

In still another embodiment, wherein the web-based application 102 is modular learning system, the user 108 may be a learning application authoring user. Accordingly, the web-based application 102 enables a learning application authoring user to manage the drafting, editing, testing, publishing, selling and updating of learning content in applications through an interface displayed on learning application authoring user device. The learning application authoring user composes individual pieces of learning content which may be purchased and used by a learning user.

In yet another embodiment, wherein the web-based application 102 is modular learning system, the user 108 can be a learning application translating user. The web-based application 102 enables a learning application translating user to manage the translation and translation updates of learning content in applications and sale of such services to microlearning content application authors through an interface displayed on a user device 106. The translations are provided to the web-based application 102 and may be stored with the corresponding learning application to enable providing instructions to learning users in a variety of languages.

In an embodiment, wherein the web-based application 102 is commercial platform, the user 108 can be a seller or vendor or vending user. The web-application 102 enables a selling user to exhibit and promote his goods on the web-based application.

In a subsequent embodiment, the user 108 may be a buyer or purchaser or purchasing user. Accordingly, the web-based application 102 would enable buyer to browse through the goods indicated by the seller over the web-based application platform.

The user 108 communicates with the web-based application through a network component 104. The network component 104 includes, but not limited to, a wireless area network, a local area network (LAN), wide area network (WAN), virtual private network (VPN), a General Packet Radio Service (GPRS) network, an Enhanced Data for Global Evolution (EDGE) network, Code division multiple access (CDMA) network, internet, computer network and the like.

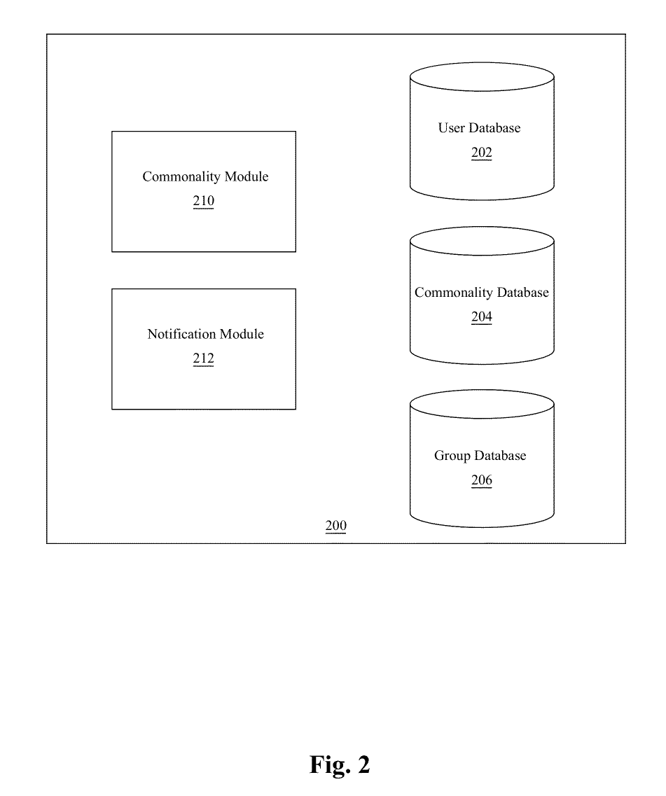

FIG. 2 illustrates a block diagram of a web-based application showing the various modules and databases involved in the invented system 200. In accordance with this invention the system comprises a User Database 202, a Commonality Database 204 and a Group Database 206. In addition to databases as mentioned earlier, system 200 further comprises a Commonality Module 210 and a Notification module 212.

The User Database 202 is configured for receiving, storing, updating and retrieving plurality of user profile attributes and non-user profile attributes. The user database 202 may also be configured for receiving, storing, updating and retrieving plurality of data fields regarding purchases made by the user over an e-learning or e-commerce platform. Depending on the intended use of the web-based application, the user database 202 may be configured for maintaining additional user profile attributes and non-user profile attributes for the user 108.

In accordance with this embodiment and invention hereinafter, the user profile attributes or data or fields or elements would encompass information such as name, address, locality and contact details of the user. The user attributes may also encompass the details regarding the user group to which the user has voluntarily subscribed, if any.

Further, in accordance with this embodiment and invention hereinafter, the non-user profile attributes or data or fields or elements would comprise attributes relating to the activities performed by the user 108 over the web-based application 102. Therefore, the non-user profile attributes would differ for each user in accordance with the role he performs over the web-based application 102 as described below.

In first embodiment, for learning user, the user database 202 may be configured to maintain learning history outside the web-based application system 102, learning application performance history on the web-based application 102, purchase history of learning applications as well as purchase history of a host of related microlearning purchase items like, for example, timed access to learning facility, timed access to tutor, and purchase of access to a learning tool.

In second embodiment, for tutoring user, the user database 202 may be configured to maintain information about the learning application(s) being tutored by the tutoring user; the information of the learning users he has tutored as well is currently tutoring, as user-profile attributes.

In third embodiment, when the user 108 is a learning application authoring user, the user database 202 is configured for maintaining the history of applications authored by the learning application authoring user. The user database 202 may be further configured for maintaining the data regarding the learning users who have purchased the learning application authored by the learning application authoring user 108, either in part or full. The user database 202 may further be configured for maintaining the information about subject heads in which the learning application author has authored the learning application(s).

In fourth embodiment, when the user 108 is a learning application translating user, the user database 202 is configured for storing the history of the learning applications translated by the translating user. The user database 202 may, further, be configured for maintaining the information about the subject head under which the learning application translating user has translated the learning applications.

In another embodiment, wherein the user 108 is a seller, the user database 202 may be configured for maintaining the details about the items which have been put by seller for selling. The user database 202 may, further, be configured for maintaining history of the buyers or purchasers who have bought goods from the seller through web-based e-commerce application system.

In yet another embodiment, wherein the user 108 is a buyer, the user database 202 is configured for maintaining the history of the purchases performed by the user over the web-based application 102. The user database 202 may further be configured for maintaining the details of the sellers from whom the buyer has brought the goods.

A user database 202 is configured for receiving, storing, updating and retrieving a plurality of identity items or data fields of each user, such as, but not limited to user's name, age, date of birth, address, mobile number, e-mail address, and other personal details. Depending on the user's role in the web-based application 102, the user database 202 maintains additional information regarding the user. The user database 202 may maintain information about each type of user based on the user's role in the system. The user information may be stored in a plurality of databases, each database associated with a user role, or the user roles may be stored in a single user database 202.

The commonality database 204 is configured for receiving, storing, updating and retrieving the common interests, that is, those non-user profile attributes which are in common between at least two users.

In an embodiment, where the user 108 is a learning user or learner, the common non-user profile attribute may be selected from the common learning application, common learning application authors, common learning application translators, common certifying authority, common learning application template developer, common language, common location, common class, common tutors, common subject heads, common learning institution, common learning facilities, common workshops, common learning tools and common funding user or combinations thereof.

In subsequent embodiment, wherein the user 108 is a tutoring user or tutor, the common non - user profile attribute could comprise common subject heads, common learning users, common learning application author, common certifying authority, affiliation to common learning institutions, common learning facilities, common workshops, common learning tools and common funding user or combination thereof.

In further embodiment, wherein the user 108 is a learning application authoring user, the common non-user profile attribute could comprise common subject heads, common learning users, common tutors, common certifying authorities, affiliation to common learning institutions, common learning facilities, common workshops, common learning tools and common funding user or combination thereof.

In still further embodiment, wherein the user 108 is a learning application translating user, the common non-user profile attribute would include comprise common subject heads, common learning users, common tutoring user, common learning application author, common certifying authority, affiliation to common learning institutions, common learning facilities, common workshops, common learning tools and common funding user or combination thereof.

In yet another embodiment, wherein the user 108 is a seller, the common non-user profile attribute would be selected from the common buyers, common products, common manufacturers, common location or locality, common wholesalers and/or distributors and the like.

In further embodiment, the user 108 is a buyer, the common non-user profile attribute would comprise of the common sellers, common products purchased, common manufacturers, common location or locality, common wholesalers and/or distributors and the like.

The group database 206 is configured for receiving, storing, updating and retrieving the details of the person(s) present in a user network group formed on the basis of at least one common non-user profile attribute. The group database 206 is further configured for receiving, storing, updating and retrieving the details of user network groups.

The system of invention further comprises of Commonality Module 210. The commonality module of 210 is configured for retrieving the user details, inclusive of user profile attributes and non-user profile attributes, from the User database 202. The commonality module 210 is further configured for determining the common interests based on the user details stored in the user database 202 and form a commonality matrix based on determined common interests. On forming commonality matrix, the commonality module 202 stores the hence formed commonality matrix in commonality database 204.

In an embodiment, the commonality module 210 may be further configured for designing a meta-content based on the data entered by the user 108 at the time of signing up. The meta-content hence created may be stored in the user database 202 or may be stored in a distinct database. The creation of metadata may enhance the efficacy of the system.

The system of invention further comprises of a notification module 212. Said module 212 is configured for retrieving the commonality matrix from the commonality database 204 and displaying a notification on the user device 106 regarding such users in whose case the commonality matrix has at least one common interest or a certain minimum number of common interests. Such a notification may be referred to as commonality notification. On the basis of the common matrix, the notification module 212 creates a notification event, whereby notification module 212 displays a notification on the user device 106 displaying the information about the user whose commonality matrix has a pre-determined number of common interests in commonality matrix. Notification module 212 is further configured for storing the details of such users in Group Database 206 who satisfy the conditions of commonality and who have been added to the user network group by the user 108.

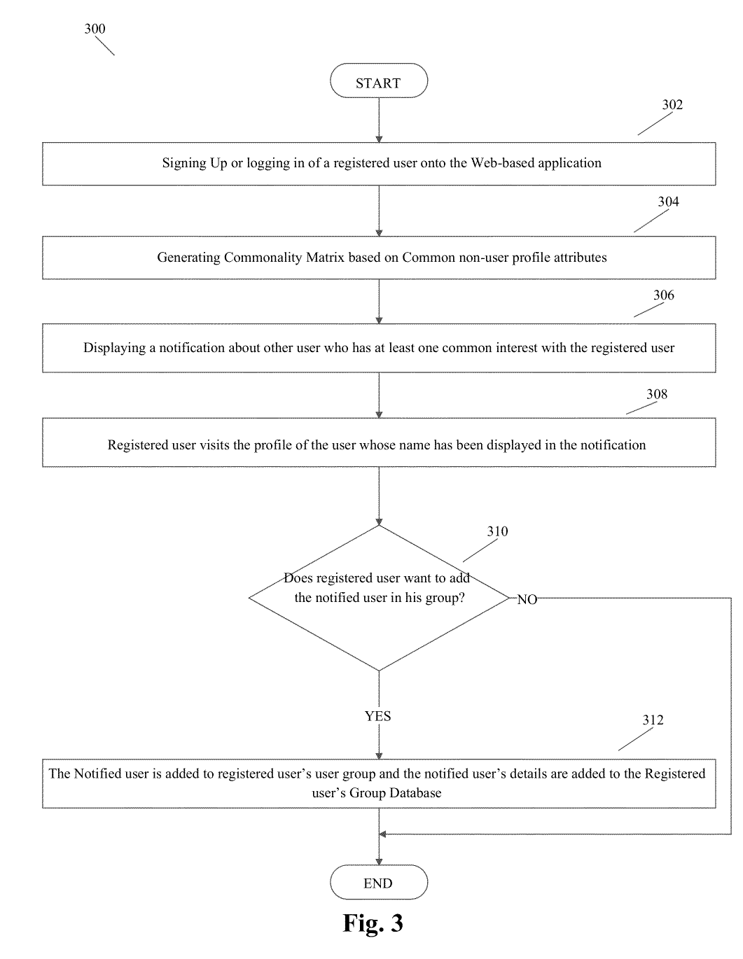

An embodiment of the process of invention is illustrated in FIG. 3. In accordance with this embodiment the process 300 for establishing user network groups based on commonality comprises of steps as mentioned below.

In Step 302, the registered user 108 logs in on the web-based application 102, through a user interface which is displayed on the user device 106. Alternatively, if user 108 is visiting the web-based application 102 for the first time, the user 108 may sign up through a user interface which may be displayed on the display unit of the user device 106 and become a registered user. On signing up or logging in the web-based application 102, the data entered by the user 108 is stored in the user database 202.

In an embodiment, the data stored in the user database 202 can be segregated as user profile attributes and non-user profile attributes. The segregation of data may be physical separation or a virtual separation.

In subsequent embodiment, the user profile attributes may consists of such information or attributes of the user as may be required for establishing the identity of the user. Such information would consists of including but not limited to name of the user, address of the user as well as contact information of the user. Whereas the non-user profile attributes would encompass every other attribute which may not be used to establish the identity of the user 108. Such a non-user profile attributes would encompass data regarding the activity of the user 108 over the web-based application 102. Said non-user profile attributes would, typically, include, but is not limited to, the data regarding purchases performed by the user, learning applications performed and subscribed by the user 108, the services requested by the user, age, qualifications and the like. The non-user profile attributes would further embody such other user specific data as may be prescribed for a particular user, as described above.

In step 304, the commonality module 210 extracts the data from the user database 202 to establish at least one common interest attribute or data and subsequently form a commonality matrix. Commonality matrix is composed of a plurality of common interest arrayed together. The common interest would compose of non-user profile attributes which are common between the user and at least one other user, both of whom have registered on the web-based application 102. Subsequently, the commonality module 210 further stores the formulated commonality matrices in the commonality database 204.

In step 306, the notification module 212 extracts the commonality matrices stored in commonality database 204. The extracted commonality matrices are then scrutinized to ascertain if the extracted commonality matrices satisfy a pre-defined commonality condition(s).

For the purpose of this invention the pre-defined commonality condition constitutes a condition wherein the commonality matrix contains at least one common interest. Alternatively, the commonality matrix should contain a pre-defined threshold number of common interests to satisfy the pre-defined commonality condition.

In an embodiment, whereby the commonality matrix satisfies the pre-defined commonality condition, the notification module 212 causes display of a notification on the display screen of the registered user device 106 based on established commonality matrix.

In an embodiment, the notification can be displayed as a pop-up notification or a scrolling notification. The notification might list the details of the other user, provided the commonality matrix satisfies the pre-defined commonality condition. Said details might contain the name of the other user, a link to such other users profile on the web-based application and the list and number of common interests as contained in commonality matrix. For the purpose of this specification, the other user as defined herein before would be referred to as “notified user”

In step 308, the user chooses to visit the profile of such notified user whose commonality matrix satisfied the pre-defined commonality condition. On visiting the notified user profile, the registered user decides whether he would like to add the notified user to his group or not, as in step 310.

In an embodiment, where the user decides to add the notified user to his group, he may do so by clicking a button or a link presented on the notified user's profile. On clicking the displayed link the system adds the notified user to the user's user network group in step 312.

In an alternative embodiment, where the user decides not to add the other user to his group, the process terminates.

On addition of the notified user to registered user's network group, the details of such other user are added to the user's group database 206.

Thus the method and system for establishing or creating user network group is disclosed. The created user network group may benefit user while purchasing or shopping any item over internet through on-line e-commerce portals or any/all services offered by web-based application or systems. User may combine their activities with other users in his/her network group like playing game, online, shopping, purchasing common interest items, sharing experiences, travel with or learn with or any operation of their interest on web-based application.

In further advantageous embodiment, the system provides for targeting a certain user group for procuring additional benefits. Such benefits could include certain special offers on certain services or workshops. Hence formed user network group based on common-interest non-user profile attributes could be used by companies or organization or marketing agencies for targeted advertisements. For example, where web-based application is a modular learning application, network group of user created based on common interest attribute like subject as mathematics could be shown advertisements like short term courses in trigonometry or workshop on advance mathematics. In another example, where web-based application is an e-commerce application, network group of users created with common interest attribute like interested in buying electronic items are targeted if there are any new gadgets or mobile phones available by respective companies on the given platform.

In a subsequent advantageous embodiment, whereby the web-based application 102 is a modular learning system, the formation of user network groups might give an opportunity for certain service providers like authors to put up their work for review to such a group which might have the author's subject head as a common interest. Further, a workshop administrating user may arrange to invite users in a certain group for a workshop which might focus on certain specialized field.

In another subsequent advantageous embodiment, where the web-based application 102 is a commercial platform, the vendors might offer certain discounts to members of such group who have him as a common interest. The vendor may additionally prescribe a discount or any other offers which the vendor may deem fit to retain and/or expand his customer base. Thus the web-based application system would give advertisements or offers or discounts to those established network user groups based on their common interest attributes. Marketing or advertisements would be more powerful.

Although the method for establishing user network group is described as being composed of various steps, fewer or more steps could comprise the method (e.g., Receiving New User Data, Update/Refresh Request from Authorized User, and Review Data Items for Users, Aggregate Purchase/Review Ratings Data for User, Aggregate Scoring and Review Data Items of Other Users in Same Parameter, Aggregate Purchase/Review Ratings Items of Other Users in Same Parameter), with the configuration still falling within the scope of various embodiments.

### BEST MODE

In an exemplary embodiment, a registered user, A, buys an electronic gadget from an e-commerce site. On purchase the system 200 retrieves and stores the transaction details in a user database. For the purpose of this embodiment, the transaction details as stored in user database would include but not limited to the product, the make of product, type, price and the location of the purchase as non-user profile attributes.

The commonality module 210 retrieves non-user profile attributes for user A stored in the user database 202. Simultaneously, the commonality module also retrieves the same non-user profile attributes, that is, the product, the make of product, and the location of the purchase for other users as well. After retrieving the non-user profile attributes for all the users, the commonality module establishes a plurality of commonality matrices. The matrices hence formed are stored in a commonality database 204.

The plurality of commonality matrices stored in the commonality database 204 are retrieved and scrutinized by the notification module 212. The hence extracted commonality matrices are than scrutinized by the notification module 212 to determine if the stored commonality matrix satisfies a pre-defined commonality condition. In accordance with this embodiment the pre-defined commonality condition may be that commonality matrix has at least three elements, accordingly the notification module 212 sorts the data retrieved from the commonality database 212 such that only those commonality matrices are selected which satisfies the pre-defined commonality condition. The notification module 212 finally sends a notification to the user A whereby the notification contains those user profiles who meet the pre-defined commonality condition.

After going through the notification, user A may decide to visit one or more of the notified user profiles. The thus visited notified user profiles are added to the user network group of A.

In another exemplary embodiment, considering S a student aspiring to register himself over a modular learning management system the procedure to be followed by the user S is as below.

Since user S is not a registered member at the modular learning system she has to register herself on the modular learning system through a user interface displayed on her user device 106 screen by entering the required details in fields provided for such purpose. On submission of the required details the details are sorted as user profile attributes and non-user profile attributes and are stored in user database 202. In accordance with this embodiment, the non-user profile attributes would include the learning applications subscribed by S, the subject of learning applications, the tutors for said learning applications, the learning facilities required for said application and workshops requested by S.

The commonality module 210 retrieves the non-user profile attributes from the user database 202. Simultaneously, the commonality module also retrieves the same non-user profile attributes, that is, the learning applications subscribed by other users, the subject of learning applications, the tutors for said learning applications, the learning facilities required for said application and workshops. After retrieving the non-user profile attributes for all the users, the commonality module establishes a plurality of commonality matrices. The matrices hence formed are stored in a commonality database 204.

The plurality of commonality matrices stored in the commonality database 204 are retrieved and scrutinized by the notification module 212. The hence extracted commonality matrices are than scrutinized by the notification module 212 to determine if the stored commonality matrices satisfy a pre-defined commonality condition. In accordance with this embodiment the pre-defined commonality condition may be that commonality matrix has at least five elements, accordingly the notification module 212 sorts the data retrieved from the commonality database 212 such that only those commonality matrices are selected which satisfies the pre-defined commonality condition. The notification module 212 finally sends a notification to the user S whereby the notification contains those user profiles that satisfy the pre-defined commonality condition.

After going through the notification, user S may decide to visit one or more of the notified user profiles. The thus visited notified user profiles are added to the user network group of S.

### Exemplary Computing Environment

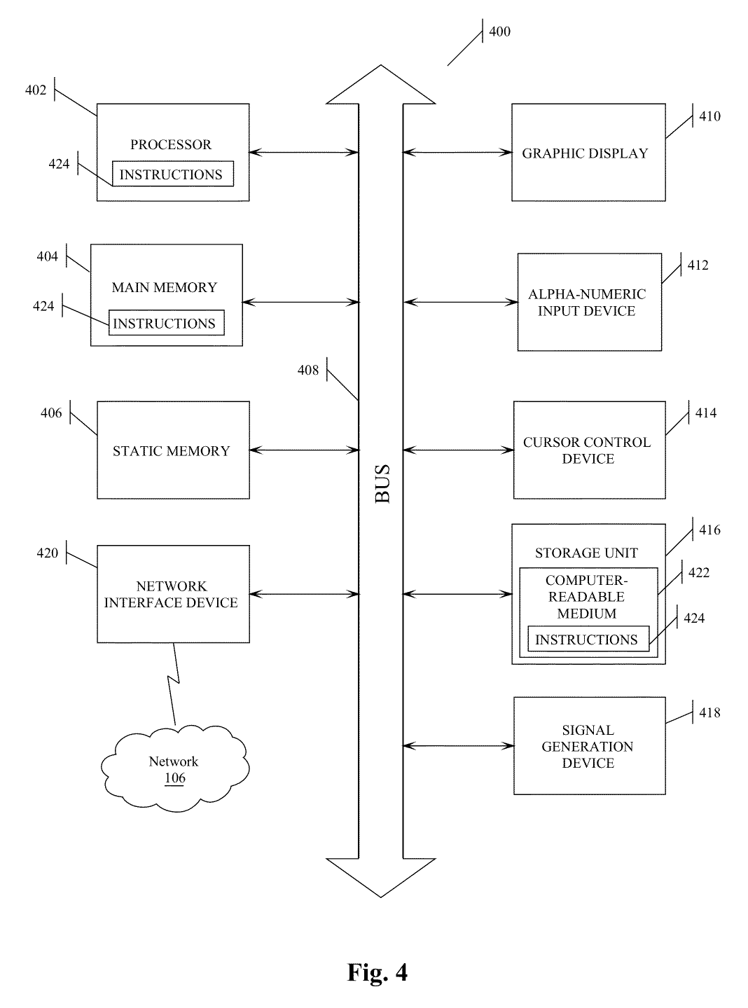

Specifically, FIG. 4 shows a diagrammatic representation of a machine in the example form of a computer system 400 within which instructions 424 (e.g. software) for causing the machine to perform any one or more of the methodologies discussed herein may be executed. In alternative embodiments, the machine operates as a standalone device or may be connected (e.g. networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 424 to perform any one or more of the methodologies discussed herein.

The example computer system 400 includes a processor 402 (e.g. a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include a graphics display unit 410 (e.g. a plasma display panel (PDP), a liquid crystal display (LCD), a projector, or a cathode ray tube (CRT)). The computer system 400 may also include alphanumeric input device 412 (e.g. a keyboard), a cursor control device 414 (e.g. a mouse, a trackball, a joystick, a motion sensor, or other pointing instrument), a storage unit 416, a signal generation device 418 (e.g. a speaker), and a network interface device 420, which also are configured to communicate via the bus 408.

The storage unit 416 includes a computer readable medium 422 on which is stored instructions 424 (e.g. software) embodying any one or more of the methodologies or functions described herein. The instructions 424 (e.g. software) may also reside, completely or at least partially, within the main memory 404 or within the processor 402 (e.g. within a processor's cache memory) during execution thereof by the computer system 400, the main memory 404 and the processor 402 also constituting machine-readable media. The instructions 424 (e.g. software) may be transmitted or received over a network 104 via the network interface device 420.

While computer readable medium 422 is shown in an example embodiment to be a single medium, the term “computer-readable medium” should be taken to include a single medium or multiple media (e.g. a centralized or distributed database, or associated caches and servers) able to store instructions (e.g. instructions 424). The term “computer-readable medium” shall also be taken to include any medium that is capable of storing instructions (e.g. instructions 424) for execution by the machine and that cause the machine to perform any one or more of the methodologies disclosed herein. The term “computer-readable medium” includes, but not be limited to, data repositories in the form of solid-state memories, optical media, and magnetic media.

The web-based application 102 may be one or more servers in which one or more methods disclosed herein are performed. The processor 402 may be a microprocessor, a state machine, an application specific integrated circuit, a field programmable gate array, etc. (e.g. Intel® Pentium® processor). The main memory 404 may be a dynamic random access memory and/or a primary memory of the web-based application 102. The static memory 406 may be a hard drive, a flash drive, and/or other memory information associated with the web-based application 102.

The bus 408 may be an interconnection between various circuits and/or structures of the web-based application 102. The video display 410 may provide graphical representation of information on the web-based application 102. The alphanumeric input device 412 may be a keypad, keyboard and/or any other input device. The cursor control device 414 may be a pointing device such as a mouse.

The storage unit 416 may be a hard drive, a storage system, and/or other longer term storage subsystem. The signal generation device 418 may be a bios and/or a functional operating system of the web-based application 102. The network interface device 420 may be a device that may perform interface functions such as code conversion, protocol conversion and/or buffering required for communication to and from a network (e.g. the network 142 of FIG. 1). The computer readable medium 422 may provide instructions 424 on which any of the methods disclosed herein may be performed. The instructions 424 may provide source code and/or data code to the processor 402 to enable any one/or more operations disclosed herein. For example, the web-based application 102 may be stored in the form of instructions 424 on a storage medium such as the main memory 404 and/or the machine readable medium 422 such as compact disk.

The performance of certain of the operations may be distributed among the one or more processors, not only residing within a single machine, but deployed across a number of machines. In some example embodiments, the one or more processors or processor-implemented modules may be located in a single geographic location (e.g. within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g. a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Although the present embodiments have been described with reference to specific example embodiments, it will be evident that various modifications and changes may be made to these embodiments without departing from the broader spirit and scope of the various embodiments. For example, the various devices, modules, databases, etc. described herein may be enabled and operated using hardware circuitry (e.g. complementary metal-oxide-semiconductor (CMOS) based logic circuitry), firmware, software and/or any combination of hardware, firmware, and/or software (e.g. embodied in a machine readable medium).

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

According to the embodiments described in FIG. 1 through 4, various methods and electric structures may be embodied using transistors, logic gates, and electrical circuits (e.g. Application Specific Integrated Circuitry and/or in Digital Signal Processor circuitry). It will be appreciated that the various operations, processes, and methods disclosed herein may be embodied in a machine-readable medium and/or a machine accessible medium compatible with a data processing system (e.g. a server) and may be performed in any order. Accordingly, the specification and drawings are to be regarded in an illustrative rather than a restrictive sense.

While particular embodiments and applications have been illustrated and described, it is to be understood that the disclosed embodiments are not limited to the precise construction and modules disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for establishing a user network group comprising:
logging in by a registered user in a web-based application;
establishing a commonality database based on common non-user profile attributes stored in a user database;
establishing a commonality matrix based on the common non-user profile attributes stored in the commonality database;
displaying a notification to the registered user based on established commonality matrix;
visiting notified user's profile by the registered user; and
adding notified user to registered user's network group.

2. The method of claim 1, wherein the method comprises:
signing up by the user on the web-based application;
storing and registering the user profile in the user database to become the registered user;
updating the commonality database based on the common non-user profile attributes stored in the user database;
establishing the commonality matrix based on the common non-user profile attributes stored in the commonality database;
displaying the notification to the registered user based on the established commonality matrix;
visiting notified user's profile by the registered user; and
adding notified user to the registered user's network group.

3. The method of claim 1, wherein the user is a learner or learning user and/or tutoring user or tutor or teacher and/or a learning application authoring user and/or a learning application translating user and/or a seller or vendor or vending user and/or a buyer or purchaser or purchasing user or any combination thereof.

4. A system for establishing a user network group comprising:
a user database configured for storing user profile attributes and non-user profile attributes;
a commonality module configured for establishing a commonality matrix;
a commonality database configured for storing the commonality matrix formed by the commonality module;
a notification module configured for displaying notification on a user device connected to a web-based application through a network; and
a group database configured for storing details of the user network groups.

5. The system of claim 4, wherein the user is a learner or learning user and/or tutoring user or tutor or teacher and/or a learning application authoring user and/or a learning application translating user and/or a seller or vendor or vending user and/or a buyer or purchaser or purchasing user or any combination thereof.

6. A computer readable medium embodying instructions for method for establishing a user network group comprising:
logging in by a registered user in a web-based application;
establishing a commonality database based on common non-user profile attributes stored in user database;
establishing a commonality matrix based on the common non-user profile attributes stored in the commonality database;
displaying a notification to the registered user based on established commonality matrix;
visiting notified user's profile by the registered user; and
adding notified user to registered user's network group.

7. The computer readable medium of claim 6, wherein the method comprises:
signing up by a user on the web-based application;
storing and registering the user profile in the user database to become the registered user;
updating the commonality database based on the common non-user profile attributes stored in the user database;
establishing the commonality matrix based on the common non-user profile attributes stored in the commonality database;
displaying the notification to the registered user based on the established commonality matrix;
visiting notified user's profile by the registered user; and
adding notified user to the registered user's network group.

8. The computer readable medium of claim 6, wherein the user is a learner or learning user and/or tutoring user or tutor or teacher and/or a learning application authoring user and/or a learning application translating user and/or a seller or vendor or vending user and/or a buyer or purchaser or purchasing user or any combination thereof.
